(19) United States
(12) Patent Application Publication
(10) Pub. No.: US 2026/0097469 A1
(43) Pub. Date: Apr. 9, 2026

(54) SELF-CENTERING CLAMPING RING AND SEALING BOOT WITH SUCH A CLAMPING RING

(71) Applicant: ZF Friedrichshafen AG, Friedrichshafen (DE)

(72) Inventor: Harold Hopkinson, III, West Bloomfield, MI (US)

(73) Assignee: ZF Friedrichshafen AG, Friedrichshafen (DE)

(21) Appl. No.: 18/905,774

(22) Filed: Oct. 3, 2024

(51) Int. Cl. B25B 5/14

(52) U.S. Cl. CPC B25B 5/14

(57) ABSTRACT

A clamping ring has a ring body with an annular shape. A plurality of fingers distributed around the inside of ring body and extend radially inward from the ring body, where each of the plurality of fingers is configured to deform radially. Rigid sections are interspersed with the plurality of fingers. Also disclosed is a scaling system including the clamping ring.

### TECHNICAL FIELD

The present disclosure relates generally to chassis components for vehicles. Specifically, the present disclosure relates to a self-centering clamping ring and to a sealing system that includes such a clamping ring.

### BACKGROUND

Vehicle suspension and steering components use a variety of ball joints that are commonly sealed with a sealing boot. Such ball joints are present, for example, in toe links, tie rods, and control arms of vehicles, among other components. The sealing boot is commonly made of a flexible and resilient material, such as rubber or similar material, and can include an embedded sealing ring, which can be made of metal. This clamping ring includes deformable tabs that are distributed in a spaced-apart arrangement around the inside of the ring body, where the tabs extend radially inward from the ring body. When the sealing boot is pressed onto the joint assembly, the tabs can deform radially and act as retention springs to urge the material of the sealing boot against the joint body and provide resistance from pull-off.

### SUMMARY

The present disclosure is directed to a self-centering clamping ring and to a sealing boot incorporating the self-centering clamping ring. In one example, the clamping ring has tabs that extend radially inward from the ring body. A stop surface is arranged on the ring body between adjacent tabs. The stop surfaces limit the radial deviation from center when the ring is installed.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the disclosed subject matter.

### BRIEF DESCRIPTION OF THE DRAWINGS

FIG. 1 illustrates a clamping ring in accordance with the prior art.

FIG. 2 illustrates a clamping ring in accordance with an embodiment of the present disclosure.

FIG. 3 illustrates a cross-sectional view of the clamping ring of FIG. 2 as viewed along line A-A.

FIG. 4 illustrates a ball joint assembly with a rubber sealing boot that incorporates a clamping ring, in accordance with an embodiment of the present disclosure.

FIG. 5 is a cross-sectional view of the ball joint assembly of FIG. 4.

FIG. 5A illustrates an enlarged view of region 5A circled in FIG. 5

FIG. 5B illustrates an enlarged view of region 5B circled in FIG. 5.

The figures depict various embodiments of the present disclosure for purposes of illustration only. Numerous variations, configurations, and other embodiments will be apparent from the following detailed discussion.

### DETAILED DESCRIPTION

Disclosed is a clamping ring having a ring body with an annular shape. Fingers are distributed around an inside of the ring body and extend radially inward from the ring body. Each of the fingers is configured to plasticly deform radially. For example, when installed on a housing of a ball joint, the fingers deform due to interference with the housing. Rigid sections are interspersed with the plurality of fingers. In some embodiments, the ring has a quantity of fingers so that each of the fingers is equally balanced with respect to the rigid sections. The ring can have an even number or an odd number of fingers. In this way, spring force of a given finger is balanced or nearly balanced. Also disclosed is a sealing system that includes the clamping ring embedded in a sealing area of an elastomeric boot. For example, the sealing boot is configured for use with ball joints in a vehicle.

### Overview

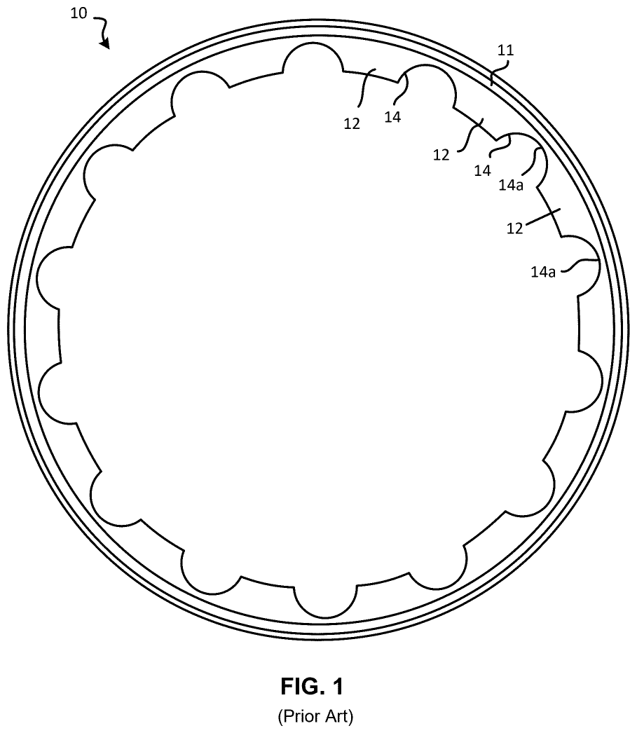

As illustrated in FIG. 1, a clamping ring 10 of the prior art has fingers 12 distributed around the inside of the ring 10, where each of the fingers 12 extends radially inward from the annular ring body 11 and functions as a spring to exert a retention force on the ball joint housing when installed. Adjacent fingers 12 are separated by an arcuate cutout 14 of hemispherical shape. This geometry allows each of the fingers 12 to deform radially when pressed onto a joint housing, for example. Each finger 12 tends to bend about the most narrow part 14a of the cutout 14 that is adjacent the ring body 11. Note that the clamping ring 12 has an even number of fingers 12 so that each finger is opposite of another finger. Thus, the position of the ring between two opposite fingers 12 is determined solely by a balance of spring forces from these fingers.

When the clamping ring 10 is incorporated into a sealing boot, the position of the clamping ring 10 and the boot (not shown) that houses the ring depends on a balance of spring forces around the ring. Spring forces from each of the fingers 12 can vary around the ring due, for example, to a variation in material properties, deformation and potentially yielding of some fingers more than others during press-on, and/or geometry of the clamping ring 10. In addition, due to manufacturing differences, the spring force of the fingers are not equal. This can result in misalignment of the sealing system during installation, or variations in the clamping ring itself. Thus, existing clamping rings 10 allow for off-center positions when installed. When the ring is not centered, the sealing system can have pre-strained rubber that contributes to poor fold characteristics. This poor fold can contribute to poor durability, poor scaling, and the potential for a shorter life of the ball joint, resulting in higher failure rates and poor marketability for ball joints.

In view of these challenges, a need exists for an improved clamping ring and for a scaling boot incorporating such a clamping ring. The present disclosure addresses these needs and others by providing a sealing ring having an internal shape that self-centers due to rigid sections of the ring being interspersed between adjacent fingers. These rigid sections do not deform or yield (or comparatively yield very little) and instead function as a hard stop to guide the ring to be axis-symmetric to the ball joint housing. In some embodiments, the clamping ring has an evenly distributed number of fingers so that each finger is positioned and limited by opposing rigid section. As such, the displacement of the ring from being centered on the ball joint are reduced compared to existing clamping rings. The rigid sections facilitate the clamping ring centering on the housing and provide a more equal spring displacement, thereby providing a more evenly balanced retention around the ring and sealing interface. This is significantly improved when unbalanced loads are observed. The clamping ring can have an even or odd number of fingers, including four, six, seven, eleven, twelve, sixteen or twenty fingers, for example. Numerous variations and embodiments will be apparent in light of the present disclosure.

### Example Embodiments

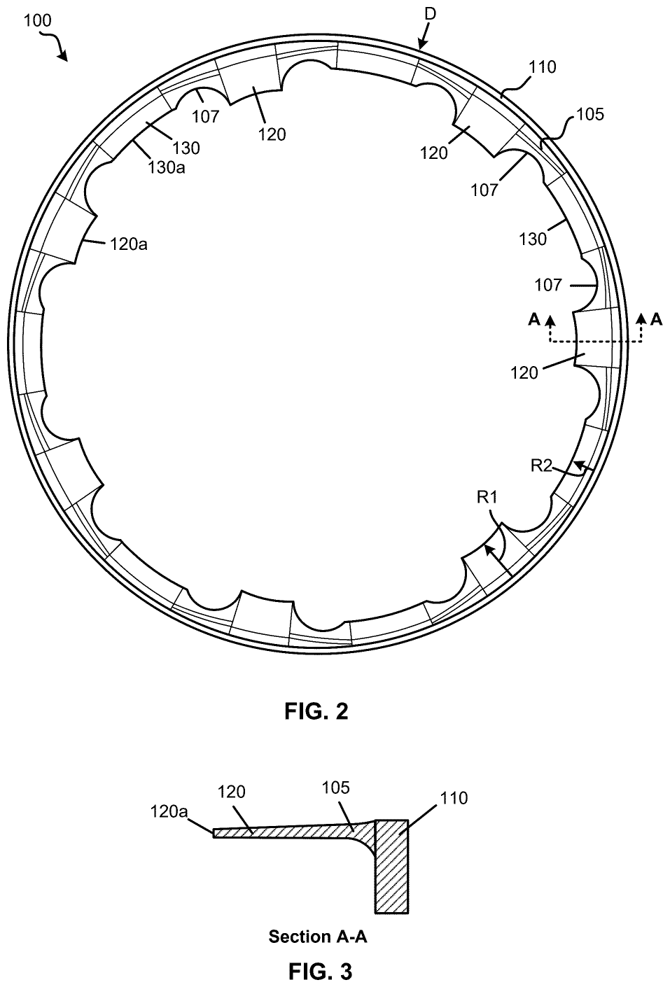

FIG. 2 illustrates a clamping ring 100 in accordance with an embodiment of the present disclosure. FIG. 3 illustrates a cross-sectional view of the clamping ring 100 of FIG. 2 as viewed along line A-A. The clamping ring 100 has a ring body 110 of annular shape. A web 105 extends radially inward from the ring body 110 and includes fingers 120 and rigid sections 130. The rigid sections 130 are interspersed circumferentially with the fingers 120. A cutout or recess 107 is between and connects each finger 120 to the adjacent rigid section 130. Here, the recesses 107 have a curved shape that extends into the web 105 towards the ring body 110. As such, the recesses 107 further define the fingers 120 and enable a relatively more flexible finger 120 that can deform during installation compared to rigid sections 130, which do not or which are comparatively rigid.

In the example shown, the radially inner end 120a of each finger 120 has a curved shape that is part of a circle. That is, radially inner ends 120a of the fingers 120 follow a circular geometry. The radially inner end 130a of the recesses 130 similarly follows a circular geometry, although of a circle of greater diameter. In other embodiments, the fingers 120 and/or the rigid sections 130 can have a linear profile at the radially inner end 120a, 130a.

In some embodiments, the ring body 110 is structured like a rim and has a rectangular cross-sectional shape, such as shown in FIG. 3. In some such embodiments, the ring body 110 has a greater radial thickness compared to the web 105, including fingers 120 and rigid sections 130 that extend radially inward from the ring body 110. In other embodiments, the ring body 110 has a thickness that is comparable or equal to that of the web 105. In some embodiments, the fingers 120 have a reduced thickness compared to rigid sections 130 and compared to the ring body 110. The recesses 107 can have a thickness that is equal to or less than that of the rigid sections. In some embodiments, the web 107 decreases in thickness as it extends radially inward. For example, the fingers 120, rigid sections 130, and recesses 107 have the same thickness at a given radial distance from the ring body 110. Due to their increased radial dimension, radially inner portions of the fingers 120 then have a reduced thickness. In such embodiments, the force required for each finger 120 to deform increases with increasing interference with a joint housing, for example. In other embodiments, the thickness along the ring body 110 and web 105 (including fingers 120 and rigid sections 130) is the same or substantially the same (e.g., ±10%).

The cross-sectional profile of the sealing ring 100 can resemble a T-shape, an L-shape, a 90° curve, or other shape as deemed suitable for a particular application. In some embodiments, the fingers 120 extend radially inward from the ring body 110 by a radial dimension R1 that is from 150% to 250% of a radial dimension R2 of the rigid sections 130. In one example embodiment radial dimension R1 is from 160-170% of radial dimension R2.

In the example shown, the clamping ring 100 has an odd number of fingers 120 and odd number of rigid sections 130 so that each finger 120 is positioned opposite of one of the rigid sections 130. Depending on diameter, the number of fingers and rigid sections should control to enable an axisymmetric boot position and retention. This is unlike clamping rings 10 of the prior art where an even number of fingers results in each finger being opposite another finger with the centering of the ring/seal relying on the spring rate of each finger 120. Here, the clamping ring 100 has seven fingers 120; other numbers of fingers are acceptable and may depend on the diameter of the clamping ring 100. For example, the clamping ring has an outer diameter D from 20-40 mm and has from five to thirteen fingers 120. The clamping ring can have a smaller or greater outer diameter D and can have more or fewer fingers as deemed appropriate for a given application.

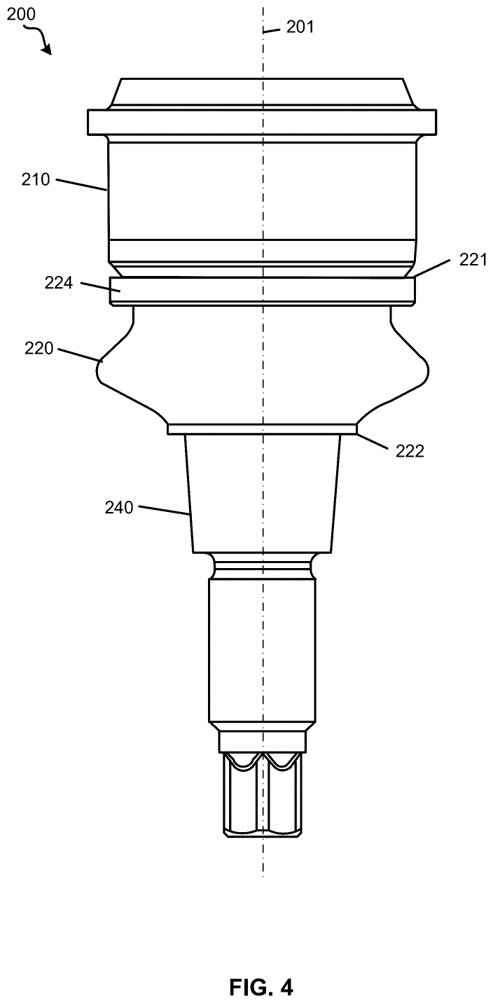

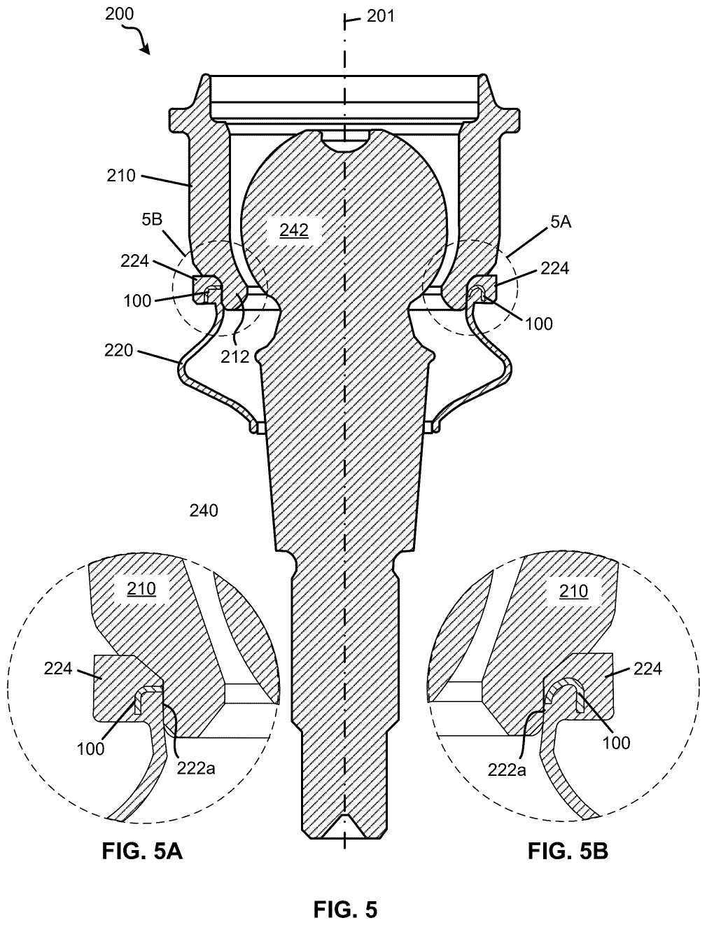

FIG. 4 illustrates a ball joint assembly 200 with a sealing boot 220 that incorporates a clamping ring 100, in accordance with an embodiment of the present disclosure. FIG. 5 is a cross-sectional view of the ball joint assembly 200 of FIG. 4. FIGS. 5A and 5B illustrate enlarged views of regions 5A and 5B, respectively, shown circled in FIG. 5. FIG. 5B is a section taken through a finger of the clamping ring and FIG. 5A is a section taken through a rigid section 130 of the clamping ring 100. The assembly 200 includes a housing 210, a sealing boot 220, and a shaft component 240 with a ball head 242. The housing 210 generally has a cup-like or socket shape and is configured to receive the ball stud 242 of the shaft component 240.

The sealing boot 220 is made of a flexible and resilient elastomeric material, such as rubber, polyurethane, or similar material. The sealing boot 220 has a tubular geometry that extends along a central axis 201 from a first end 221 to a second end 222. For example, the sealing boot 220 can have a bellows configuration. The first end 221 has a sealing area 224 of increased thickness that houses the sealing ring 100. In this example, the sealing ring 100 is embedded in the sealing area 224 of the sealing boot 220 with fingers 120 and rigid sections closely adjacent to an inner surface 224a of the sealing area 224. In its installed state with the sealing area 224 pressed onto the rim 212 of the housing 210, fingers 120 deform due to interference with the housing 210, such as shown at the right side of FIG. 5. In its deformed state, each of the fingers 120 functions as a spring to exert a force against the rim 212 of the housing 210. In contrast, the rigid sections 130 function as a hard stop to limit displacement of the sealing boot 220 relative to the central axis 201 of the assembly 200, such as shown in circled region 5A on the left side of FIG. 5 and in FIG. 5A. In this way, the clamping ring 100 is self-centering and resists off-axis installation.

### Further Example Embodiments

The following examples pertain to further embodiments, from which numerous permutations and configurations will be apparent.

Example 1 is a clamping ring having a ring body with an annular shape. Fingers are distributed around an inside of the ring body and extend radially inward from the ring body. Each of the fingers is configured to deform radially. Rigid sections are interspersed with the plurality of fingers.

Example 2 includes the clamping ring of Example 1, where each of the fingers is positioned opposite of one of the rigid sections.

Example 3 includes the clamping ring of Example 1 or 2, where clamping ring has an odd number of fingers.

Example 4 includes the clamping ring of Example 3, where the clamping ring has from seven to twenty fingers.

Example 5 includes the clamping ring of any one of Examples 1-4, where each of the fingers is circumferentially spaced on each side from one of the rigid sections by a curved portion.

Example 6 includes the clamping ring of any one of Examples 1-5, where individual fingers extend radially inward by a first radial distance from the ring body, the rigid sections extend radially inward by a second radial distance from the ring body, and where the first radial distance at least 150% of the second radial distance.

Example 7 includes the clamping ring of any one of Examples 1-6, where the clamping ring has an outer diameter from 20 mm to 40 mm.

Example 8 is a sealing boot comprising a tubular boot body extending along a central axis from a first end to a second end, the first end defining a sealing area. A clamping ring is embedded in the sealing area and has a ring body with an annular shape. Fingers are distributed around an inside of the ring body and extend radially inward from the ring body. Each of the fingers is configured to deform radially. Rigid sections are interspersed with the fingers.

Example 9 includes the sealing boot of Example 8, where the sealing boot has a bellows configuration.

Example 10 includes the sealing boot of Example 8 or 9, where each of the fingers is positioned opposite of one of the rigid sections.

Example 11 includes the sealing boot of any one of Examples 8-10, where the clamping ring has an odd number of fingers.

Example 12 includes the sealing boot of Example 11, where the clamping ring has from seven to eleven fingers.

Example 13 includes the sealing boot of any one of Examples 8-12, where each of the fingers is circumferentially spaced on each side from one of the rigid sections by a curved portion.

Example 14 includes the sealing boot of any one of Examples 8-13, where the fingers extend radially inward by a first radial distance from the ring body and the rigid sections extend radially inward by a second radial distance from the ring body, and where the first radial distance at least 150% of the second radial distance or enough to adequately provide a retention force.

Example 15 includes the sealing boot of any one of Examples 8-14, where the sealing area has an outer diameter from 20 mm to 60 mm.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

1. A clamping ring comprising:
a ring body having an annular shape;
a plurality of fingers distributed around an inside of the ring body and extending radially inward from the ring body, each of the plurality of fingers configured to deform radially; and
rigid sections interspersed with the plurality of fingers.

2. The clamping ring of claim 1, wherein each of the plurality of fingers is positioned opposite of one of the rigid sections.

3. The clamping ring of claim 1, wherein the plurality of fingers includes from seven to eleven fingers.

4. The clamping ring of claim 1, wherein the plurality of fingers includes an odd number of fingers.

5. The clamping ring of claim 1, wherein each of the plurality of fingers is circumferentially spaced on each side from one of the rigid sections by a curved portion.

6. The clamping ring of claim 1, wherein the fingers extend radially inward by a first radial distance from the ring body and the rigid sections extend radially inward by a second radial distance from the ring body, the first radial distance at least 150% of the second radial distance.

7. The clamping ring of claim 1, wherein the clamping ring has an outer diameter from 20 mm to 40 mm.

8. A sealing boot comprising:
a tubular boot body extending along a central axis from a first end to a second end, the first end defining a sealing area; and
a clamping ring embedded in the sealing area, the clamping ring comprising:
a ring body having an annular shape;
a plurality of fingers distributed around an inside of the ring body and extending radially inward from the ring body, each of the plurality of fingers configured to deform radially; and
rigid sections interspersed with the plurality of fingers.

9. The sealing boot of claim 8, wherein the sealing boot has a bellows configuration.

10. The sealing boot of claim 8, wherein each of the plurality of fingers is positioned opposite of one of the rigid sections.

11. The sealing boot of claim 8, wherein the plurality of fingers includes from seven to eleven fingers.

12. The sealing boot of claim 8, wherein each of the plurality of fingers is circumferentially spaced on each side from one of the rigid sections by a curved portion.

13. The sealing boot of claim 8, wherein the fingers extend radially inward by a first radial distance from the ring body and the rigid sections extend radially inward by a second radial distance from the ring body, the first radial distance at least 150% of the second radial distance.

14. The sealing boot of claim 8, wherein the sealing area has an outer diameter from 20 mm to 60 mm.
